(19) United States
(12) Patent Application Publication
(10) Pub. No.: US 2006/0282268 A1
(43) Pub. Date: Dec. 14, 2006

(54) Method for a menu-based voice-operated device, and menu-based voice-operated device for realizing the method

(75) Inventor: Chien-Lung Huang, Liu-Lu Li (TW)

Correspondence Address: BANNER & WITCOFF, 1001 G STREET N W, SUITE 1100, WASHINGTON, DC, 20001, US

(73) Assignee: Universal Scientific Industrial Co., Ltd., Nan-Tou Hsien (TW)

(21) Appl. No.: 11/220,660

(22) Filed: Sep. 8, 2005

(30) Foreign Application Priority Data
Jun. 14, 2005 (TW) 94119628

(51) Int. Cl. G10L 21/00

(52) U.S. Cl. 704/275

(57) ABSTRACT

A method for a menu-based voice-operated device includes the steps of: enabling the voice-operated device to provide main menu items of a main menu for selection by a user; enabling the voice-operated device to detect a voice command from the user; enabling the voice-operated device to match the detected voice command with the main menu items of the main menu; enabling the voice-operated device to provide sub-menu items of a sub-menu associated with the matching main menu item for selection by the user; enabling the voice-operated device to detect another voice command from the user; enabling the voice-operated device to match the detected voice command with the sub-menu items of the sub-menu; and enabling the voice-operated device to execute the matching sub-menu item. A voice-operated device for realizing the method is also disclosed.

### BACKGROUND OF THE INVENTION

1. Field of the Invention

This invention relates to a voice-operated device, more particularly to a voice-operated device that provides a hierarchical cascading menu for selection by a user.

2. Description of the Related Art

Voice-operated devices, such are those typically used in an automobile, are configured with a list of items for selection by a user.

The known voice-operated devices are disadvantageous in that, since voice recognition technology is still fairly new, they may not be able to properly recognize voice commands issued by the user. As such, the known voice-operated devices are likely to operate in a manner not intended by the user.

### SUMMARY OF THE INVENTION

Therefore, the object of the present invention is to provide a method for a voice-operated device that ensures operation of the voice-operated device as intended by a user.

Another object of the present invention is to provide a voice-operated device that can overcome the aforesaid drawback of the prior art.

According to one aspect of the present invention, a method for a menu-based voice-operated device comprises the steps of:

A) enabling the voice-operated device to provide main menu items of a main menu for selection by a user;

B) enabling the voice-operated device to detect a voice command from the user;

C) enabling the voice-operated device to match the voice command detected in step B) with the main menu items of the main menu;

D) enabling the voice-operated device to provide sub-menu items of a sub-menu associated with the matching main menu item for selection by the user;

E) enabling the voice-operated device to detect another voice command from the user;

F) enabling the voice-operated device to match the voice command detected in step E) with the sub-menu items of the sub-menu; and

G) enabling the voice-operated device to execute the matching sub-menu item.

According to another aspect of the present invention, a menu-based voice-operated device comprises a user interface unit, a user input unit, and a controller unit. The user interface unit is adapted to provide main menu items of a main menu for selection by a user. The user input unit is adapted to detect voice commands from the user. The controller unit is coupled to the user interface unit and the user input unit, and is operable so as to match a voice command detected by the user input unit with the main menu items of the main menu. The user interface unit is further adapted to provide sub-menu items of a sub-menu associated with the matching main menu item for selection by the user. The controller unit is further operable so as to match another voice command detected by the user input unit with the sub-menu items of the sub-menu.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic block diagram of the preferred embodiment of a menu-based voice-operated device according to the present invention;

FIGS. 2A to 2C are flowcharts to illustrate the preferred embodiment of a method for a menu-based voice-operated device according to the present invention;

FIG. 3 is a schematic view to illustrate main menu items of a main menu;

FIG. 4 is a schematic view to illustrate sub-menu items of a sub-menu; and

FIG. 5 is a schematic view to illustrate lower-level sub-menu items of a lower-level sub-menu.

### DETAILED DESCRIPTION OF THE PREFERRED EMBODIMENT

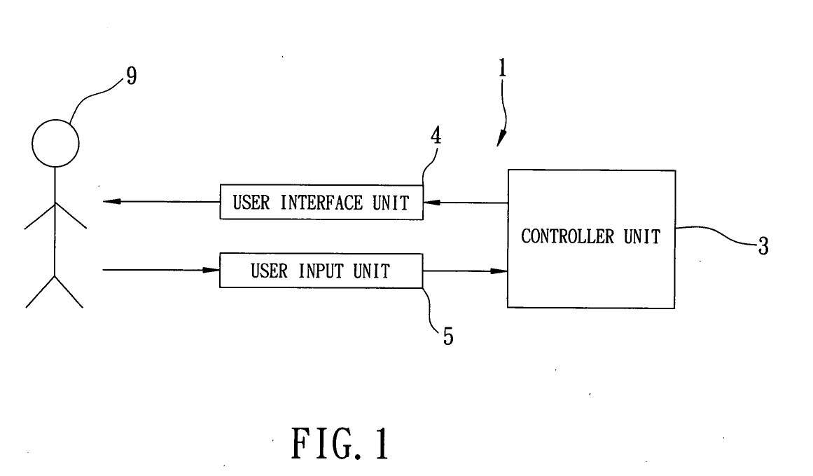

Referring to FIG. 1, the preferred embodiment of a menu-based voice-operated device 1 according to this invention is shown to include a user interface unit 4, a user input unit 5, and a controller unit 3.

In this embodiment, the voice-operated device 1 is a navigational device that is intended for use in an automobile (not shown). In an alternative embodiment, the voice-operated device 1 may be one of a multimedia device and a wireless telecommunications device.

The user interface unit 4 provides main menu items of a main menu for selection by a user 9.

The user input unit 5 detects voice commands from the user 9. In this embodiment, the user input unit 5 includes an acoustic pick-up module that includes a microphone.

The controller unit 3 is coupled to the user interface unit 4 and the user input unit 5, is configured with the main menu, and is operable so as to match the voice command detected by the user input unit 5 with the main menu items of the main menu.

The user interface unit 4 further provides sub-menu items of a sub-menu associated with the matching main menu item for selection by the user 9.

The controller unit 3 is further configured with the sub-menu, and is further operable so as to match another voice command detected by the user input unit 5 with the sub-menu items of the sub-menu.

In this embodiment, the user interface unit 4 includes a graphical user interface module that includes a display. As such, the main menu items and the sub-menu items are provided to the user 9 through the display of the graphical user interface module. In an alternative embodiment, the user interface unit 4 includes an interactive voice interface module that includes a speaker. As such, the main menu items and the sub-menu items are provided to the user through the speaker of the interactive voice interface module. It is noted that in yet another embodiment, the user interface unit 4 may include both the graphical user interface module and the interactive voice interface module.

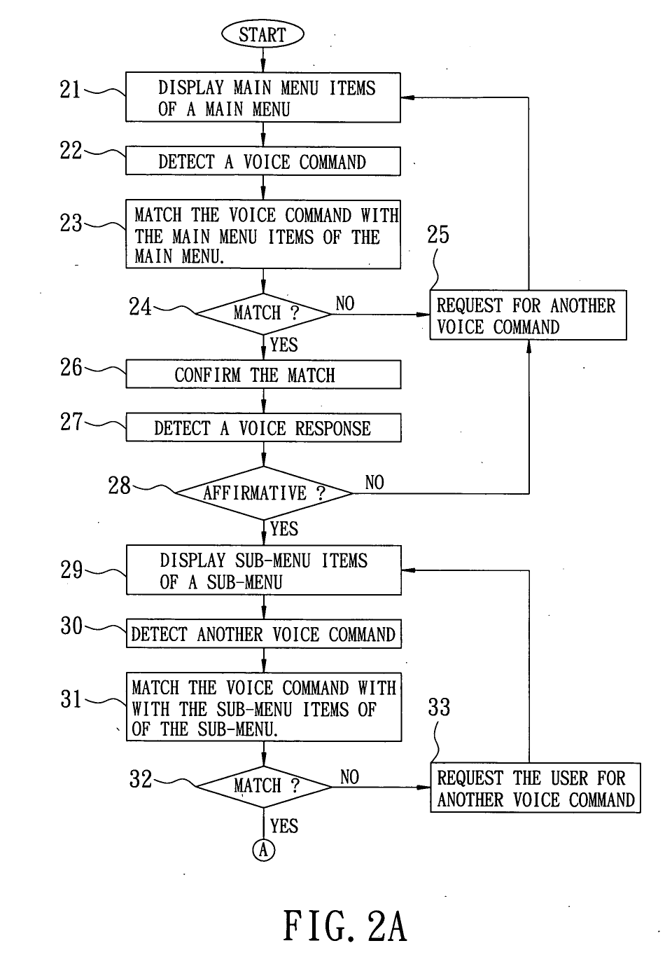

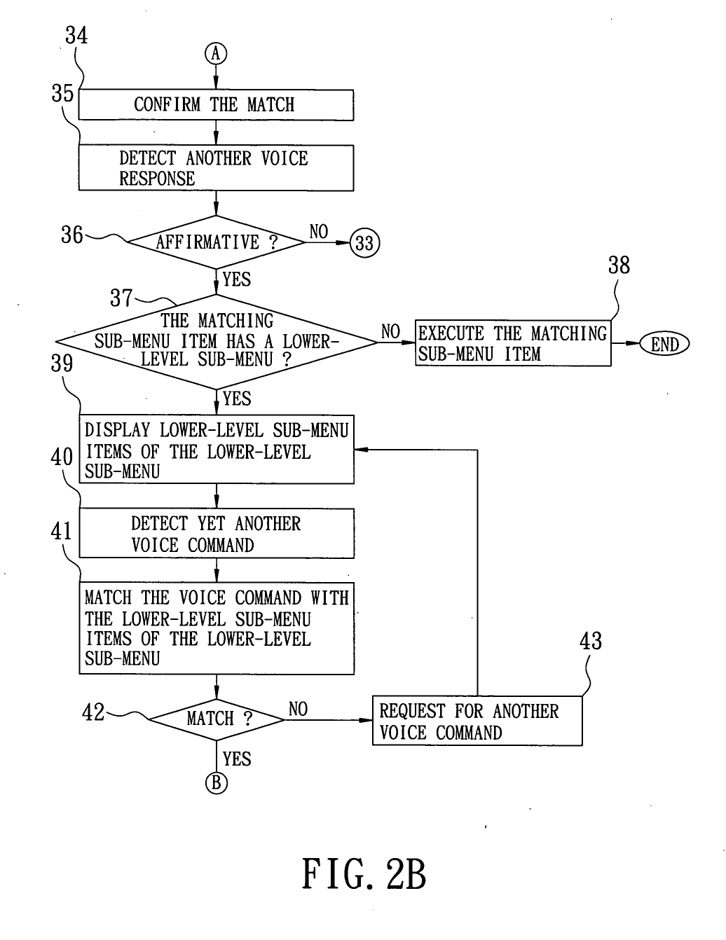

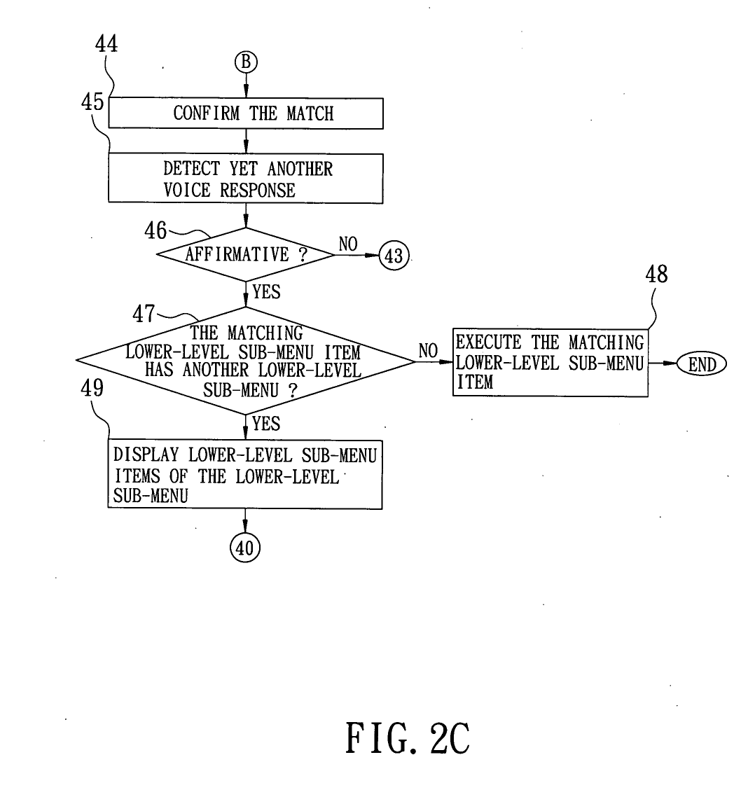

The preferred embodiment of a method for the aforementioned menu-based voice-operated device 1 according to this invention will now be described with further reference to FIGS. 2A to 2C.

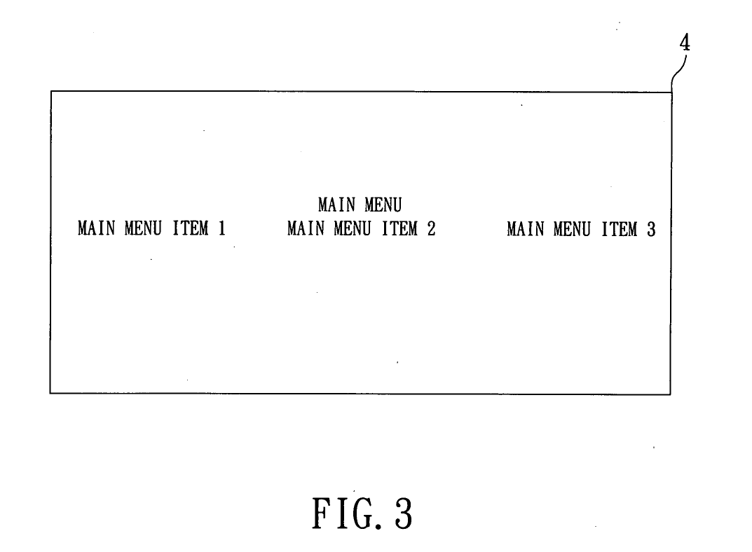

In step 21, as illustrated in FIG. 3, the user interface unit 4 of the voice-operated device 1 displays the main menu items of the main menu for selection by the user 9.

In step 22, the user input unit 5 of the voice-operated device 1 detects a voice command from the user 9.

In step 23, the controller unit 3 of the voice-operated device 1 matches the voice command detected in step 22 with the main menu items of the main menu.

In step 24, if the controller unit 3 of the voice-operated device 1 finds a match, the flow proceeds to step 26. Otherwise, the flow proceeds to step 25.

In step 25, the user interface unit 4 of the voice-operated device 1 provides a voice prompt to request the user for another voice command. Thereafter, the flow goes back to step 22.

In step 26, the user interface unit 4 of the voice-operated device 1 provides a voice prompt to confirm the match found by the controller unit 3 with the user 9.

In step 27, the user input unit 5 of the voice-operated device 1 detects a voice response from the user 9.

In step 28, if the controller unit 3 of the voice-operated device 1 determines that the voice response detected in step 27 is affirmative, the flow proceeds to step 29. Otherwise, the flow goes back to step 25.

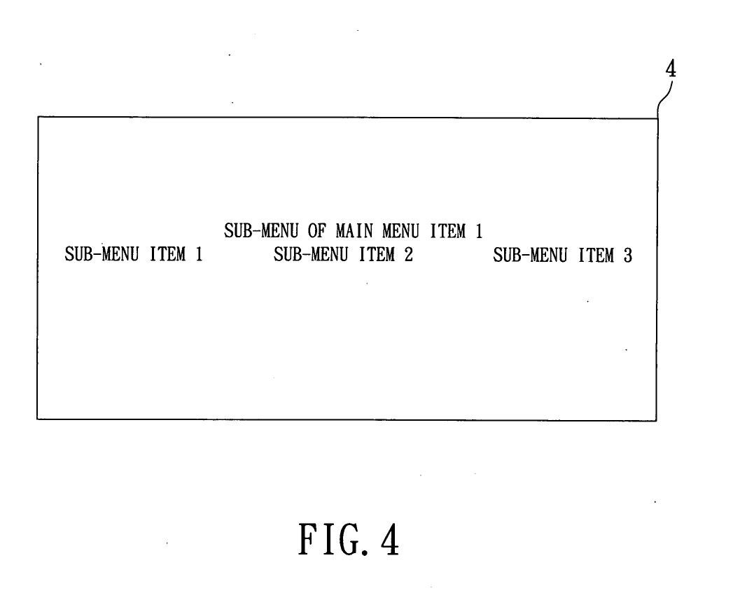

In step 29, as illustrated in FIG. 4, the user interface unit 4 of the voice-operated device 1 displays the sub-menu items of the sub-menu associated with the matching main menu item for selection by the user 9.

In step 30, the user input unit 5 of the voice-operated device 1 detects another voice command from the user 9.

In step 31, the controller unit 3 of the voice-operated device 1 matches the voice command detected in step 30 with the sub-menu items of the sub-menu.

In step 32, if the controller unit 3 of the voice-operated device 1 finds a match, the flow proceeds to step 34. Otherwise, the flow proceeds to step 33.

In step 33, the user interface unit 4 of the voice-operated device provides a voice prompt to request the user for another voice command. Thereafter, the flow goes back to step 30.

In step 34, the user interface unit 4 of the voice-operated device 1 provides a voice prompt to confirm the match found by the controller unit 3 with the user 9.

In step 35, the user input unit 5 of the voice-operated device 1 detects another voice response from the user 9.

In step 36, if the controller unit 3 of the voice-operated device 1 determines that the voice response detected in step 35 is affirmative, the flow proceeds to step 37. Otherwise, the flow goes back to step 33.

In step 37, if the controller unit 3 of the voice-operated device 1 determines that the matching sub-menu item has a lower-level sub-menu associated therewith, the flow proceeds to step 39. Otherwise, the flow proceeds to step 38.

In step 38, the controller unit 3 of the voice-operated device 1 executes the matching sub-menu item.

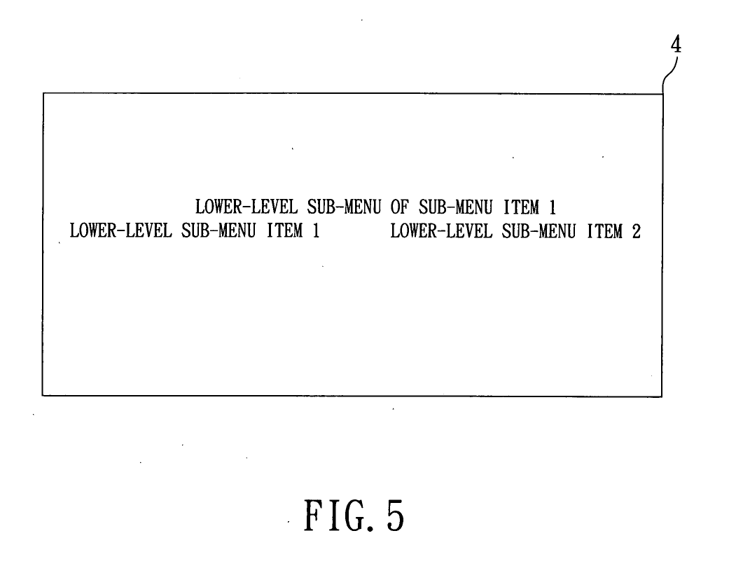

In step 39, as illustrated in FIG. 5, the user interface unit 4 of the voice-operated device 1 displays lower-level sub-menu items of the lower-level sub-menu associated with the matching sub-menu item for selection by the user 9.

In step 40, the user input unit 5 of the voice-operated device 1 detects yet another voice command from the user 9.

In step 41, the controller unit 3 of the voice-operated device 1 matches the voice command detected in step 40 with the lower-level sub-menu items of the lower-level sub-menu.

In step 42, if the controller unit 3 of the voice-operated device 1 finds a match, the flow proceeds to step 44. Otherwise, the flow proceeds to step 43.

In step 43, the user interface unit 5 of the voice-operated device 1 provides a voice prompt to request the user 9 for another voice command. Thereafter, the flow goes back to step 39.

In step 44, the user interface unit 4 of the voice-operated device 1 provides a voice prompt to confirm the match found by the controller unit 3 with the user 9.

In step 45, the user input unit 5 of the voice-operated device 1 detects yet another voice response from the user 9.

In step 46, if the controller unit 3 of the voice-operated device 1 determines that the voice response detected in step 45 is affirmative, the flow proceeds to step 47. Otherwise, the flow goes back to step 43.

In step 47, if the controller unit 3 of the voice-operated device 1 determines that the matching lower-level sub-menu item has another lower-level sub-menu associated therewith, the flow proceeds to step 49. Otherwise, the flow proceeds to step 48.

In step 48, the controller unit 3 of the voice-operated device 1 executes the matching lower-level sub-menu item.

In step 49, the user interface unit 4 of the voice-operated device 1 displays lower-level sub-menu items of the lower-level sub-menu associated with the matching lower-level sub-menu item for selection by the user 9. Thereafter, the flow goes back to step 40.

It is noted that, in the alternative embodiment, where the user interface unit 4 includes the interactive voice interface module, the user 9 may issue the voice command without waiting for the user interface unit 4 to finish reciting the main menu items, the sub-menu items, or the lower-level sub-menu items.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for a menu-based voice-operated device, said method comprising the steps of:
A) enabling the voice-operated device to provide main menu items of a main menu for selection by a user;
B) enabling the voice-operated device to detect a voice command from the user;
C) enabling the voice-operated device to match the voice command detected in step B) with the main menu items of the main menu;
D) enabling the voice-operated device to provide sub-menu items of a sub-menu associated with the matching main menu item for selection by the user;
E) enabling the voice-operated device to detect another voice command from the user;
F) enabling the voice-operated device to match the voice command detected in step E) with the sub-menu items of the sub-menu; and
G) enabling the voice-operated device to execute the matching sub-menu item.

2. The method as claimed in claim 1, wherein step G) includes: executing the matching sub-menu item upon determining that the matching sub-menu item has no lower-level sub-menu associated therewith, and otherwise enabling the voice-operated device to provide lower-level sub-menu items of a lower-level sub-menu associated with the matching sub-menu item for selection by the user.

3. The method as claimed in claim 1, wherein, in steps A) and D), the main menu items and the sub-menu items are provided to the user through a graphical user interface module.

4. The method as claimed in claim 1, wherein, in steps A) and D), the main menu items and the sub-menu items are provided to the user through an interactive voice interface module.

5. The method as claimed in claim 1, further comprising the step of requesting the user for another voice command when a match is not found in step C).

6. The method as claimed in claim 1, further comprising the step of requesting the user for yet another voice command when a match is not found in step F).

7. The method as claimed in claim 1, wherein the voice-operated device is one of a navigational device, a multimedia device, and a wireless telecommunications device.

8. A menu-based voice-operated device, comprising:
a user interface unit adapted to provide main menu items of a main menu for selection by a user;
a user input unit adapted to detect voice commands from the user; and
a controller unit coupled to said user interface unit and said user input unit, and operable so as to match
a voice command detected by said user input unit with the main menu items of the main menu;
wherein said user interface unit is further adapted to provide sub-menu items of a sub-menu associated with the matching main menu item for selection by the user; and
wherein said controller unit is further operable so as to match another voice command detected by said user input unit with the sub-menu items of the sub-menu.

9. The menu-based voice-operated device as claimed in claim 8, wherein said user input unit includes an acoustic pick-up module.

10. The menu-based voice-operated device as claimed in claim 8, wherein said user interface unit includes a graphical user interface module.

11. The menu-based voice-operated device as claimed in claim 8, wherein said user interface unit includes an interactive voice interface module.

12. The menu-based voice-operated device as claimed in claim 8, wherein said voice-operated device is one of a navigational device, a multimedia device, and a wireless telecommunications device.
